(19) United States
(12) Patent Application Publication
(10) Pub. No.: US 2013/0170324 A1
(43) Pub. Date: Jul. 4, 2013

(54) OPERATING METHOD AND PORTABLE ELECTRONIC DEVICE USING THE SAME

(71) Applicants: Chang-Jhu Tu, Taipei City (TW); Chun-Yi Wang, Taipei City (TW); Jian-Wei Gong, Taipei City (TW); Shuai-Feng Huang, Taipei City (TW)

(72) Inventors: Chang-Jhu Tu, Taipei City (TW); Chun-Yi Wang, Taipei City (TW); Jian-Wei Gong, Taipei City (TW); Shuai-Feng Huang, Taipei City (TW)

(73) Assignee: ASUSTeK COMPUTER INC., Taipei City (TW)

(21) Appl. No.: 13/727,615

(22) Filed: Dec. 27, 2012

Related U.S. Application Data
(60) Provisional application No. 61/583,146, filed on Jan. 4, 2012.

(51) Int. Cl. G04G 21/08; G04G 5/04

(52) U.S. Cl. CPC G04G 21/08; G04G 5/04
USPC 368/28

(57) ABSTRACT

An operating method of a clock-calendar and a portable electronic device using the same are provided, where a touch screen display of the portable electronic device displays the clock-calendar with a clock pattern. In the method, a gesture on the touch screen display corresponding to the clock-calendar is detected and analyzed, where the gesture includes a gesture starting point and a gesture finishing point on the touch screen display. After the gesture is analyzed, the clock-calendar is operated according to the gesture.

### CROSS-REFERENCE TO RELATED APPLICATION

This application claims the priority benefits of U.S. provisional application Ser. No. 61/583,146, filed on Jan. 4, 2012. The entirety of the above-mentioned patent application is hereby incorporated by reference herein and made a part of this specification.

### BACKGROUND

1. Technical Field

The disclosure relates to an operating method. Particularly, the disclosure relates to an operating method of a clock-calendar and a portable electronic device using the same.

2. Related Art

Along with continuous improvement of functionality and convenience of mobile devices (for example, smart phones or tablet PCs, etc.), mobile devices have become indispensable electronic products in modern life. Since the mobile device is portable and is easy to use, more and more users of the mobile devices are gradually accustomed to use a calendar program on the mobile device to replace a conventional paper calendar. Through the calendar program on the mobile device, the user can record daily schedule, agendum or arrange important meetings at anytime anywhere.

Regarding a current calendar program generally supported by the mobile devices, an operating interface of the calendar program is generally presented in form of bar columns or a table. Similarly, itineraries or events recorded in the calendar are also set in a regularized table, and are also presented in form of bar columns or a table, which is relatively monotonous and rigid in use.

### SUMMARY

The disclosure is directed to an operating method of a clock-calendar and a portable electronic device using the same, which effectively improves usability of the clock-calendar in the portable electronic device.

The disclosure provides an operating method of a clock-calendar, which is adapted to a portable electronic device having a touch screen display, where the touch screen display displays a clock-calendar having a clock pattern. In the method, a gesture on the touch screen display corresponding to the clock-calendar is detected, where the gesture includes a gesture starting point and a gesture finishing point. After the gesture is analyzed, the clock-calendar is operated according to the gesture.

In the operating method of the disclosure, when the gesture corresponds to an operation for creating an event, an event line segment corresponding to the event and event information corresponding to the gesture are displayed at a peripheral of the clock pattern, wherein the event line segment is used to represent a duration of the event, the gesture starting point corresponds to a start time of the event, and the gesture finishing point corresponds to an end time of the event.

In the operating method of the disclosure, an edit window is displayed on the touch screen display to edit the event.

In the operating method of the disclosure, a floating dialog box is displayed on the clock-calendar to edit the event.

In the operating method of the disclosure, when the gesture corresponds to an operation for deleting an event, the gesture starting point of the gesture corresponds to an event line segment to be deleted in the clock-calendar.

In the operating method of the disclosure, when the gesture corresponds to an operation for adjusting an event, the gesture starting point and the gesture finishing point of the gesture respectively correspond to a start time and an end time represented by an event line segment to be adjusted in the clock-calendar.

In the operating method of the disclosure, when the gesture corresponds to an operation for changing a time period of the clock pattern, the time period is changed and displayed on the clock-calendar, wherein the time period comprises an ante meridiem time period (AM) and a post meridiem time period. (PM)

The disclosure provides a portable electronic device including a touch screen display, where the touch screen display displays a clock-calendar having a clock pattern, and detects a gesture on the touch screen display corresponding to the clock-calendar, where the gesture includes a gesture starting point and a gesture finishing point. The portable electronic device further includes a processor, which is coupled to the touch screen display, and is used to analyze the gesture, and operate the clock-calendar according to the gesture.

In the portable electronic device of the disclosure, when the gesture corresponds to an operation for creating an event, an event line segment corresponding to the event and event information corresponding to the gesture are displayed at peripheral of the clock pattern, wherein the event line segment is used to represent a duration of the event, the gesture starting point corresponds to a start time of the event and the gesture finishing point corresponds to an end time of the event.

The portable electronic device of the disclosure further includes displaying an edit window on the touch screen display to edit the event.

The portable electronic device of the disclosure further includes displaying a floating dialog box on the clock-calendar to edit the event.

According to the above descriptions, in the operating method and the portable electronic device of the disclosure, after the gesture on the touch screen display corresponding to the clock-calendar is detected, the gesture is analyzed, and the clock-calendar is operated according to the gesture. Particularly, when the gesture represents the event used for creating an event, an event line segment can be displayed at the peripheral of the clock pattern, where the event line segment is used to represent a duration of the event the gesture starting point corresponds to a start time of the event and the gesture finishing point corresponds to an end time of the event. In this way, different to the calendar presented in form of a table, usability and operation fun of the calendar in the portable electronic device is effectively improved.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a functional block diagram of a portable electronic device according to an embodiment of the disclosure.

FIG. 2 is a schematic diagram of a clock-calendar according to an embodiment of the disclosure.

FIG. 3 is a flowchart illustrating an operating method according to an embodiment of the disclosure.

FIG. 4 is a schematic diagram of an event according to an embodiment of the disclosure.

FIG. 5 is a schematic diagram of displaying an edit window according to an embodiment of the disclosure.

FIG. 6 is a schematic diagram of displaying a floating dialog box according to an embodiment of the disclosure.

FIG. 7 is a schematic diagram of displaying events on a clock-calendar according to an embodiment of the disclosure.

FIG. 8 is a schematic diagram of an operation for adjusting an event according to an embodiment of the disclosure.

FIG. 9 is a schematic diagram of an operation for changing a time period of the clock pattern according to an embodiment of the disclosure.

FIG. 10 is a schematic diagram of a clock-calendar according to another embodiment of the disclosure.

### DETAILED DESCRIPTION OF DISCLOSED EMBODIMENTS

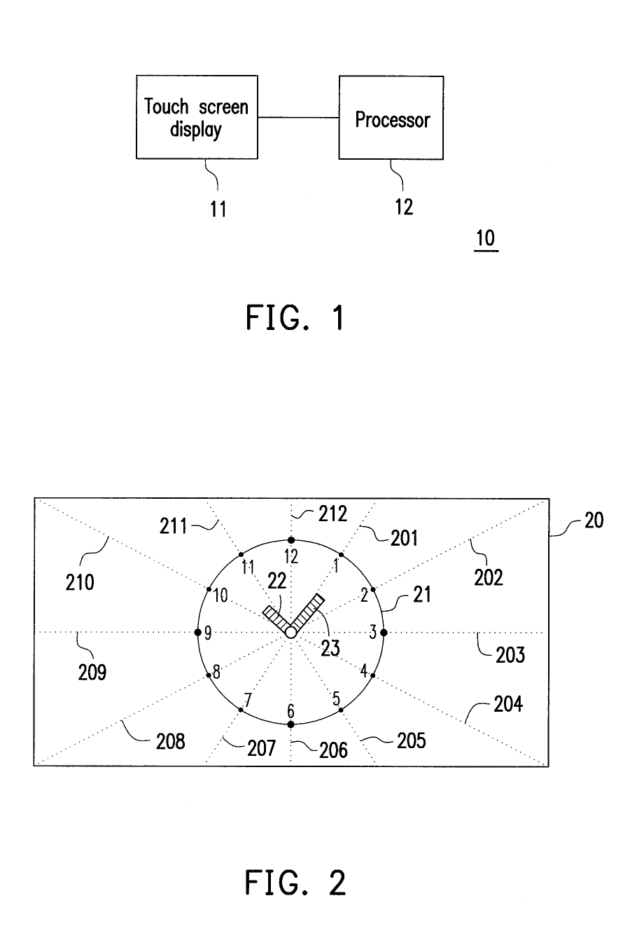

To assist understanding of the content of the disclosure, FIG. 1 is a functional block diagram of a portable electronic device according to an embodiment of the disclosure. Referring to FIG. 1, the portable electronic device 10 includes a touch screen display 11 and a processor 12. In the present embodiment, the portable electronic device 10 can be a smart phone, an electronic book, a game machine or a tablet PC, etc., which is not limited by the disclosure.

The touch screen display 11 is used to receive a touch input operation of the user, and display a corresponding output image. In the present embodiment, the touch screen display 11 may include a resistive touch panel, a capacitive touch panel, an optical touch panel, an acoustic wave touch panel, an electromagnetic touch panel, etc., which is not limited by the disclosure. Moreover, the touch screen display 11 receives an input operation of the user and displays a corresponding output image. Particularly, in the present embodiment, the touch screen display 11 may display a calendar with a clock pattern (which is referred to as a clock-calendar hereinafter), where the clock-calendar includes a pointer form clock pattern, and a time period corresponding to the clock pattern is a 12-hour-clock convention. In the present embodiment, the clock pattern displayed in the clock-calendar includes one of an hour hand, a minute hand and a second hand or a combination thereof to facilitate a user checking a present time.

FIG. 2 is a schematic diagram of the clock-calendar according to an embodiment of the disclosure. Referring to FIG. 2, the clock-calendar 20 includes a clock pattern 21, and the clock pattern 21 can present a present time through an hour hand 22 and a minute hand 23. Moreover, the clock pattern 21 may further display numbers 1-12 to represent each time unit of the 12-hour-clock convention (for example, 1:00 a.m./p.m. to 12:00 a.m./p.m.). However, in another embodiment, the clock pattern 21 may also not to display the numbers 1-12, which is determined according to an actual design requirement.

In the present embodiment, the clock-calendar 20 displays reference lines 201-202 in extension while taking the clock pattern 21 as a center, and the reference lines 201-212 respectively correspond to the time units of the 12-hour-clock convention. For example, taking the ante meridiem time period (a.m. time period) of the 12-hour-clock convention as an example, the reference lines 201-212 respectively correspond to 1:00 a.m. to 12:00 a.m. Moreover, taking the post meridiem time period (p.m. time period) of the 12-hour-clock convention as an example, the reference lines 201-212 respectively correspond to 1:00 p.m. (i.e. 13:00 of a 24-hour-clock convention) to 12:00 p.m. (i.e. 24:00 of the 24-hour-clock convention). However, the disclosure is not limited thereto, and the number of the reference lines 201-212 can be adjusted according to an actual design requirement. Moreover, the reference lines 201-212 can also be hidden lines or lightened lines, so as to avoid influencing an interface appearance of the clock-calendar 20.

Referring to FIG. 1, the processor 12 is coupled to the touch screen display 11, and executes a corresponding function according to a gesture detected by the touch screen display 11. For example, the processor 12 can analyze the gesture detected by the touch screen display 11 to operate the clock-calendar. In the present embodiment, the processor 12 can be a micro-controller, an embedded controller or a central processor, etc., though implementation of the processor of the present embodiment is not limited thereto.

The portable electronic device 10 further includes at least one storage medium to serve as a database to store related data of the clock-calendar. When the processor 12 performs operations on the clock-calendar such as adds an event, deletes an event or adjusts an event, etc., the processor synchronously performs the corresponding operation in the database. Moreover, the portable electronic device can also be connected to a remote server through a network device, so as to download calendar data stored in the remote server to update the calendar data in the portable electronic device. In this way, an effect of data synchronization between the clock-calendar in the portable electronic device and various online calendars can be achieved, so as to further improve usage convenience of the present embodiment.

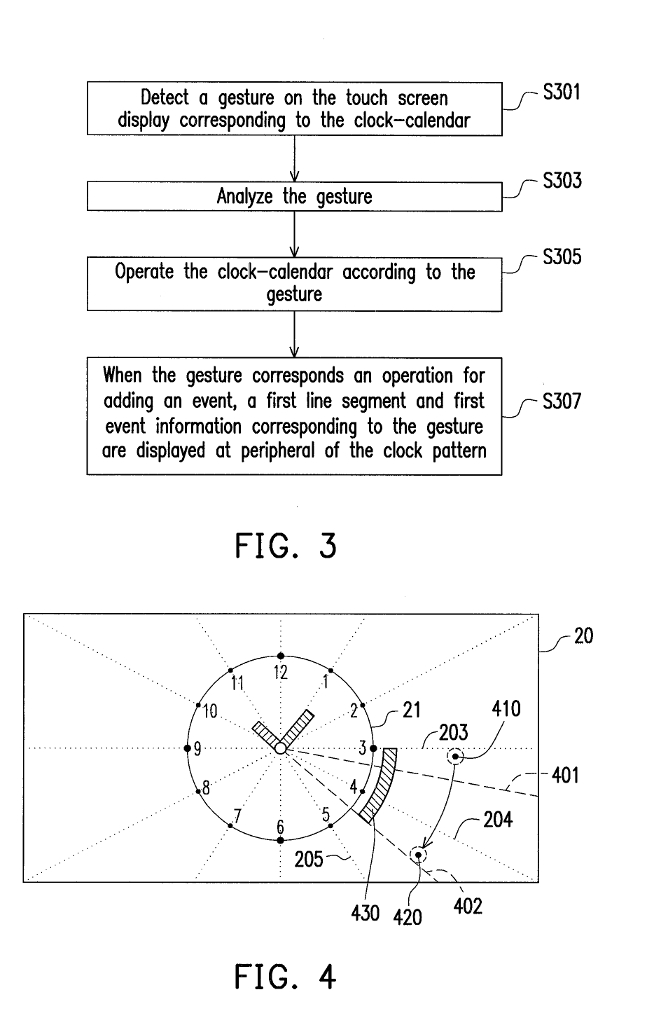

FIG. 3 is a flowchart illustrating an operating method according to an embodiment of the disclosure. Referring to FIG. 1 and FIG. 3, in step S301, an operation is performed on the touch screen display 11 corresponding to the clock-calendar, and the touch screen display 11 detects the gesture. In the present embodiment, the gesture of each time includes a gesture starting point and a gesture finishing point, and the gesture starting point and the gesture finishing point can be a same contact point or different contact points. For example, the processor 12 can determine whether the gesture starting point and the gesture finishing point are located at the same contact point according to a displacement of the gesture. When the displacement between the gesture starting point and the gesture finishing point corresponding to the gesture is greater than a threshold, the processor 12 determines that the gesture starting point and the gesture finishing point of the gesture are not located at the same contact point.

Then, in step S303, the processor 12 analyzes the gesture. For example, the processor 12 determines an operation type of the gesture according to the gesture, or analyzes a start time and an end time on the clock-calendar that are represented by the gesture according to the gesture starting point and the gesture finishing point of the gesture. In the present embodiment, the operation type of the gesture on the clock-calendar corresponds to, for example, an operation for creating an event, an operation for deleting an event, an operation for adjusting an event, an operation for changing a time period of the clock pattern of the clock-calendar and an operation for changing displayed date of the clock-calendar, etc. The number of the operation types can be increased or decreased according to an actual design requirement, or the gestures corresponding to various operations can be adjusted as well.

In an embodiment, the gesture corresponding to an operation for creating an event can be triggered when a user long-presses a contact point on the clock-calendar for more than a predetermined time (for example, 1 second), and after the operation for creating an event is triggered, the processor 12 takes a contact point of the gesture as the gesture starting point, and takes a point where the gesture disappears as the gesture finishing point.

Then, in step S305, the processor 12 operates the clock-calendar according to the gesture. For example, the processor 12 can perform a corresponding operation on the clock-calendar according to the operation type of the gesture on the clock-calendar. For example, in step S307, when the gesture corresponds to an operation for creating an event to the clock-calendar with the event information such as a agendum or a reminder, the processor 12 can display an event line segment corresponding to the event at peripheral of the clock pattern according to the gesture and input, wherein the event line segment represents a duration of the event. Moreover, the processor 12 process the gesture starting point of the gesture to a start time of the event and process the gesture finishing point of the gesture to an end time of the event.

FIG. 4 is a schematic diagram of an event according to an embodiment of the disclosure. Referring to FIG. 1 and FIG. 4, it is assumed that the user uses an input tool (for example, a finger or a stylus) to long-press a contact point 410 of the clock-calendar 20 by a predetermined time (for example, 1 second). Then, the user operates the input tool to perform a gesture motion such as dragging, sliding or nipping, etc. to reach a contact point 420 to end the gesture. A method of ending the gesture at the contact point 420 is that, for example, the user moves away the input tool from the touch screen display or the user uses the input tool to long-press the contact point 420 of the clock-calendar 20 by a predetermined time. Now, since the above gesture is complied with a feature or gesture of the event, the processor 12 determines that the gesture corresponds to an operation for creating an event. Thus, an event line segment and the event information corresponding to the event is added to the clock-calendar 20. For example, the processor 12 may take an actual time point corresponding the contact point 410 on the clock pattern 21 of the clock-calendar 20 as the start time of the event line segment, and take an actual time point corresponding to the contact point 420 on the clock pattern 21 of the clock-calendar 20 as the end time of the event line segment.

In another embodiment, the processor 12 can also obtain a reference line 203 closest to the contact point 410 and a reference line 204 closest to the contact point 420, and respectively take the time units corresponding to the reference line 203 and the reference line 204 to serve as the start time and the end time of the event. For example, referring to FIG. 4, it is assumed that the time period of the clock-calendar 20 is a p.m. time period, the processor 12 may take 3:00 p.m. (corresponding to the reference line 203) as the start time of the event and take 4:00 p.m. (corresponding to the reference line 204) as the end time of the event.

Moreover, in order to accurately obtain the start time and the end time of the event in the present embodiment, the processor 12 can also take a predetermined time section as a division unit of the start time and the end time of the event. For example, taking the predetermined time section of a half hour as an example, after the processor 12 learns that the contact point 410 falls between the reference line 203 and the reference line 204, the processor 12 further determines whether the contact point 410 is closer to the reference line 203, the reference line 204 or the reference line 401, where the reference line 203 and the reference line 401 have a difference of a half hour, and the reference line 204 and the reference line 401 also have a difference of a half hour. Referring to FIG. 4, the contact point 410 is closer to the reference line 203, so that the processor 12 takes the time unit (3:00 p.m.) corresponding to the reference line 203 as the start time of the event.

Similarly, after the processor 12 learns that the contact point 420 falls between the reference line 204 and the reference line 205, the processor 12 further determines whether the contact point 420 is closer to the reference line 204, the reference line 205 or the reference line 402. Referring to FIG. 4, the contact point 420 is closer to the reference line 402, so that the processor 12 takes the time unit (4:00 p.m.) corresponding to the reference line 402 as the end time of the event. Moreover, the aforementioned predetermined time section is not limited by the present embodiment, which can be adjusted according to an actual design requirement.

After the start time and the end time of the event is obtained, the processor 12 can display an event line segment 430 surrounding a part of the clock pattern 21 at peripheral of the clock pattern 21 to represent the duration of the event. Referring to FIG. 4, the event line segment 430 starts from the reference line 203 and terminates at the reference line 402, which represents that the duration of the event is 1.5 hours (from 3:00 p.m. to 4:30 p.m.). In this way, by checking the line segment corresponding to each event such as the agendum or remainder, etc., the user can intuitively view the start time, the end time and the duration of each event, so as to effectively improve usage convenience of the clock-calendar 20.

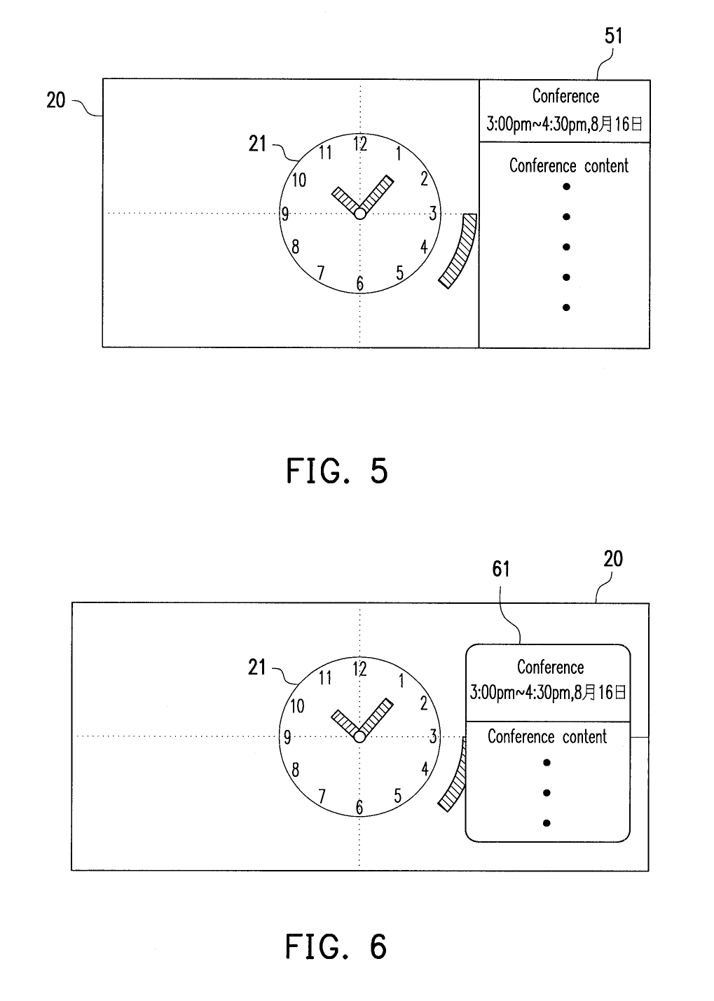

According to the above descriptions, in the present embodiment, in case that the operation for creating the event is triggered, the processor 12 can display an edit window used for editing event information on the touch screen display 11. In another embodiment, the processor 12 can display the edit window used for editing the event information on a same image of the clock pattern on the touch screen display 11. For example, FIG. 5 is a schematic diagram of displaying an edit window according to an embodiment of the disclosure. Referring to FIG. 1 and FIG. 5, in case that the event is triggered, the processor controls the touch screen display 11 to display an edit window 51. In this way, the user can edit the event information of the event through the edit window 51. The event information is, for example, an event name, a start time, an end time, a duration and/or an event detail, etc., which is not limited by the disclosure. Moreover, a size of the edit window 51 can be a full screen or any size, which is not limited by the disclosure.

Moreover, in the present embodiment, a floating dialog box can be used to replace the aforementioned edit window to facilitate the user editing the related event information. For example, FIG. 6 is a schematic diagram of displaying a floating dialog box according to an embodiment of the disclosure. Referring to FIG. 6, in case that the event is triggered, the processor 12 controls the touch screen display 11 to display a floating dialog box 61 at a same image of the clock pattern of the clock-calendar displayed on the touch screen display 11. In this way, the user can edit the event information through the floating dialog box 61. Moreover, when a size of the floating dialog box 61 is too small to completely display the event information, the user can view or edit the hidden content through a gesture motion of flipping or dragging, etc.

It should be noticed that a difference between the floating dialog box 61 and the edit window 51 of FIG. 5 lies in whether image switching is performed. Regarding the edit window 51 of FIG. 5, if the user wants to input the related event information through the edit window 51, first the user has to switch a present image from the clock-calendar 20 to the edit window 51 in order to edit the event information through the edit window 51. However, regarding the floating dialog box 61, the floating dialog box 61 is disposed on the clock-calendar 20 in an embedded manner. Therefore, through the floating dialog box 61, the user can view all of the events on the clock-calendar 20 while simultaneously editing or modifying the event information of any event, so as to avoid repeatedly perform image switching between the clock-calendar 20 and the floating dialog box 61.

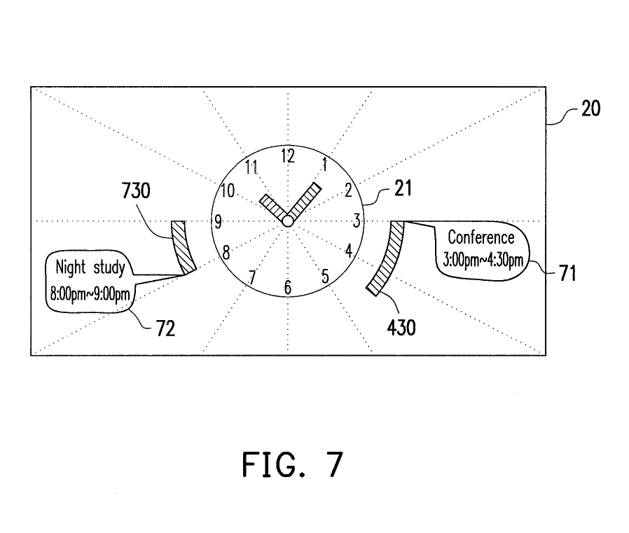

On the other hand, in the present embodiment, after the processor 12 completes processing the event, the processor 12 can directly display the event on the clock-calendar 20. For example, FIG. 7 is a schematic diagram of displaying events on the clock-calendar according to an embodiment of the disclosure. Referring to FIG. 1 and FIG. 7, according to the respective start time or end time of an event 71 and an event 72, the processor 12 takes the clock pattern 21 as a center to display the event 71 and the event 72 on the clock-calendar 20, and respectively display the even line segment 430 and an event line segment 730 at peripheral of the clock pattern 21 to respectively represent the start time, the end time and the duration of the event 71 and the event 72.

Particularly, in view of image presentation, the event line segment 430 and the event line segment 730 can be presented in different colors, thickness, or other distinguishing features, so as to facilitate identifying importance of users and/or events corresponding to the line segments (or events) through the distinguishing features of the line segments. However, the event 71 and the event 72 may also not be displayed. Alternatively, the event 71 and the event 72 are switched between hide and display according to an operation of the user.

Referring to FIG. 1 and FIG. 3 again, in the step S303, when the processor 12 analyzes the gesture to determine the operation type of the gesture on the clock-calendar to be corresponding to an operation for deleting an event, in step S305, the processor 12 removes the agendum or reminder, etc. corresponding to the event to be deleted, so as to delete any event line segment and the event information thereof from the clock-calendar and the database. Taking FIG. 7 as an example, it is assumed that the user wants to delete the event 72, and the event line segment 730 has been displayed on the clock-calendar, when the processor 12 determines that the operation type of the gesture on the clock-calendar corresponds to an operation for deleting an event, the processor 12 moves the event 72 (including the event information and the event line segment 730) from the clock-calendar 20.

Moreover, the operation for deleting the event can be triggered as the user drags the event 72 or the event line segment 730 in the touch screen display to a specified location (for example, the clock pattern or an ashbin pattern, etc.), or the user performs a throwing gesture, which is not limited by the disclosure.

Moreover, in step S303, when the processor 12 analyzes the gesture and determines that the operation type of the gesture corresponds to an operation for adjusting an event, in step S305, the processor 12 adjusts the agendum or remainder, etc. corresponding to the event to be adjusted.

Taking FIG. 7 as an example, the touch screen display displays the event 72, and when the processor 12 determines that the operation type of the gesture corresponds to an operation for adjusting an event, the processor 12 can adjust the start time of the event 72 according to the gesture, and adjust the end time of the event 72 according to the gesture.

Alternatively, in the present embodiment, the processor 12 can also prolong or shorten the duration of the event 72 according to a scaling magnitude of the adjustment event or a position of the contact point with reference of the start time of the event 72.

For example, the operation for adjusting the event may include prolonging the duration and shortening the duration. When the operation for adjusting the event is to prolong the duration, the user may perform an outspreading gesture through two fingers along opposite directions on the event 72 or the event line segment 730 (shown in FIG. 7), and the processor 12 can correspondingly prolong a length of the event line segment according to a spreading magnitude of two contact points of the fingers in the spreading gesture, so as to prolong the duration of the event. When the operation for adjusting the event is to shorten the duration, the user may perform a pinch gesture through two fingers along opposite directions on the event 72 or the event line segment 730, and the processor 12 can correspondingly shorten the length of the event line segment according to an approaching magnitude of two contact points of the fingers in the pinch gesture, so as to shorten the duration of the event.

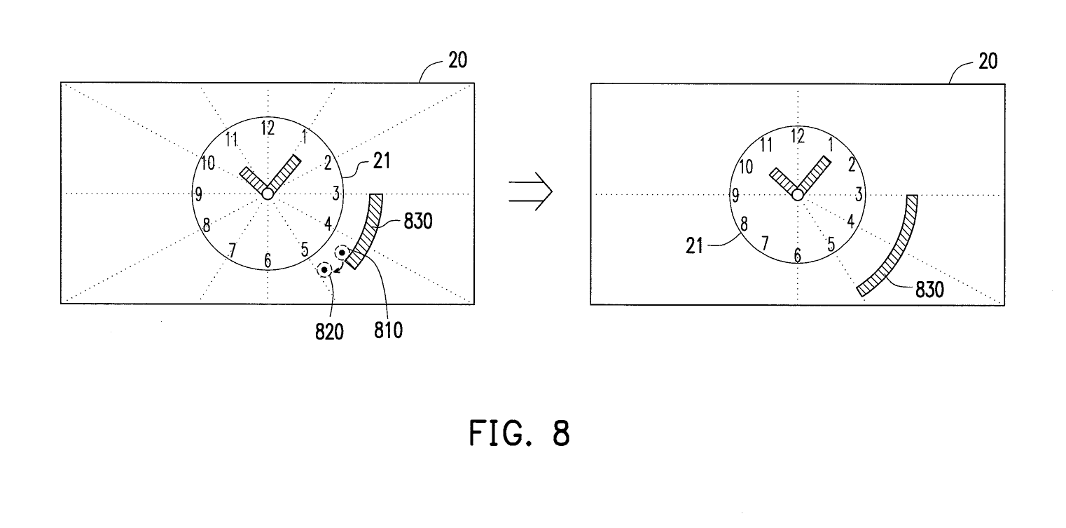

Moreover, the operation for adjusting the event can also be triggered as the user long-presses a starting and/or finishing point of a line segment (for example, the event line segment 730 of FIG. 7) through a finger, and drags the finger to adjust the start time and/or end time of the event corresponding to the line segment according to a moving position of the finger. For example, FIG. 8 is a schematic diagram of an operation for adjusting an event according to an embodiment of the disclosure. Referring to FIG. 8, it is assumed that a start time of the event corresponding to the event segment 830 is 3:00 p.m., and an end time of the event is 4:30 p.m., when the user long-presses a contact point 810 (i.e. an finishing point of the event line segment 830) through an input tool (for example, a finger) by a predetermined time (for example, 1 second) and drags the finger to a contact point 820, the end time of the event corresponding to the event line segment 830 can be correspondingly prolonged to 5:00 p.m. Similarly, the user can also shorten the end time of the event corresponding to the event line segment 830 through a similar method, or adjust the start time of the event corresponding to the event line segment 830, which is not repeated herein.

Moreover, in step S303, it is assumed that the processor 12 determines that the gesture of the user is to click the event or the event line segment on the touch screen display 11, and drag the event or the event line segment to another position of the clock-calendar, in step S305, the processor 12 adjusts the start time and the end time of the event or the event line segment according to another position of the dragged event or the event line segment.

The clock-calendar of the present embodiment can be used to effectively check the agendum or reminders at the ante meridiem (a.m.) time period or the post meridiem (p.m.) time period of one day. Therefore, in the present embodiment, different gestures can be used to change the clock-calendars corresponding to the a.m. time period of one day or the p.m. time period of one day. For example, referring to FIG. 1 and FIG. 3, in step S303, when the processor 12 analyzes the gesture to determine that the operation type of the gesture on the clock-calendar is the c operation for changing the time period of the clock pattern of the clock-calendar, in step S305, the processor 12 changes the time period of the clock pattern, and displays a corresponding clock-calendar according to the changed time period.

It is assumed that the time period of the current clock pattern of the displayed clock-calendar is the a.m. time period of the 12-hour-clock time convention, when the processor 12 determines that the operation type of the gesture on the clock-calendar is the operation for changing the time period, the processor 12 changes the time period of the clock pattern to the p.m. time period of the 12-hour-clock convention, and displays the clock-calendar corresponding to the p.m. time period. The operation for changing the time period is, for example, implemented as the user uses multiple fingers (for example, two fingers) to simultaneously perform a directional operation (for example, a dragging or sliding operation) along a first direction or a second direction, where the first direction is, for example, an upward direction of the clock-calendar positively displayed on the touch screen display 11, and the second direction is, for example, a downward direction of the clock-calendar positively displayed on the touch screen display 11.

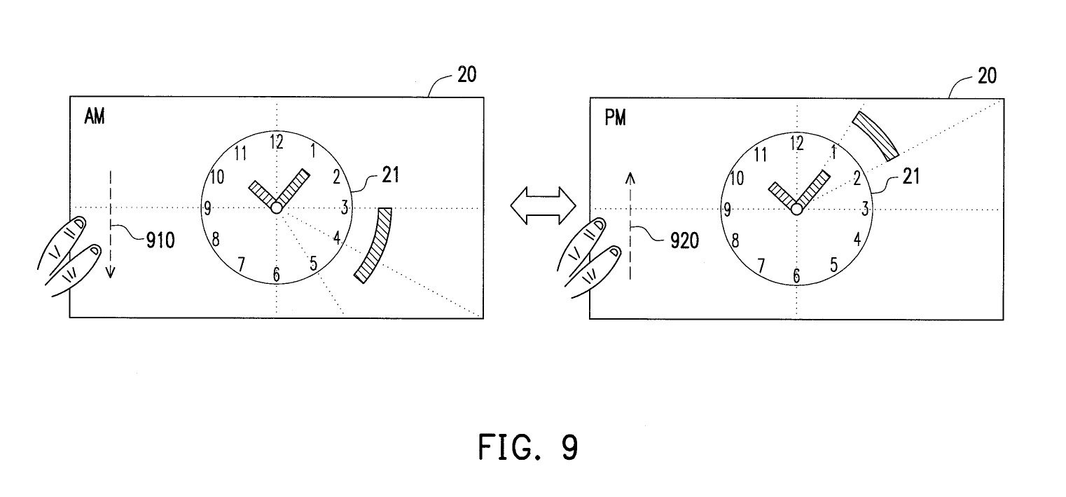

FIG. 9 is a schematic diagram of an operation for changing a time period of the clock pattern according to an embodiment of the disclosure. Referring to FIG. 9, it is assumed that the currently displayed time period of the clock pattern of the clock-calendar 20 is the ante meridiem (a.m.) time period (i.e. a left figure in FIG. 9), when the user's finger slides from top to bottom (for example, along an arrow direction 910) on the clock-calendar 20, the time period of the clock pattern of the clock-calendar 20 is changed to the post meridiem (p.m.) time period (i.e. a right figure in FIG. 9) from the a.m. time period. Then, when the user's finger slides from bottom to top (for example, along an arrow direction 920) on the clock-calendar 20, the time period of the clock pattern of the clock-calendar 20 is again changed to the a.m. time period from the p.m. time period (i.e. the left figure in FIG. 9).

Moreover, in the step S303, when the processor 12 analyzes the gesture to determine that the operation type of the gesture on the clock-calendar is the operation for changing the displayed date of the clock-calendar, in step S305, the processor 12 changes a displayed date of the clock-calendar, and displays a corresponding clock-calendar according to the date. For example, the operation for changing date of the clock-calendar is, for example, implemented as the user uses multiple fingers (for example, two fingers) to simultaneously perform a directional operation (for example, a dragging or sliding operation), for example, rightward direction of the clock-calendar positively displayed on the touch screen display 11, or a leftward direction of the clock-calendar positively displayed on the touch screen display 11. The processor 12 changes the current displayed date of the clock-calendar to the date of a previous day. When the user uses multiple fingers to simultaneously perform a directional operation to the leftward direction, the processor changes the current displayed date of the clock-calendar to the date of a next day, where the aforementioned directions can all be adjusted according to an actual design requirement, which is not limited by the disclosure.

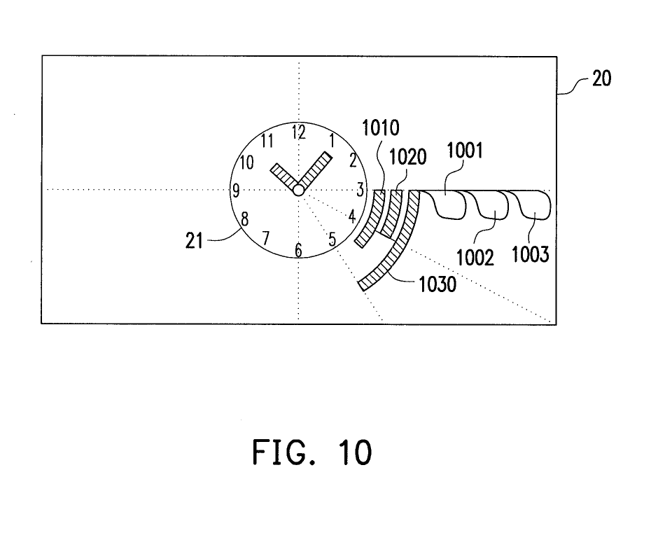

In the present embodiment, when the start time or the end time of a plurality of events are close to each other or the same, the processor 12 can sequentially arrange these events according to start time and/or end time thereof and display the same on the clock-calendar while taking the clock pattern as a center. For example, FIG. 10 is a schematic diagram of a clock-calendar according to another embodiment of the disclosure. Referring to FIG. 1 and FIG. 10, according to the line segments 1010-1030, it is known that the start time of each of the events respectively corresponding to the line segments 1010-1030 is the same time unit (for example, 3:00 PM), and the processor 12 arranges the events 1001-1003 corresponding to the line segments 1010-1030 with the overlapped start time outwards while taking the clock pattern 21 as a center and displays the same on the clock-calendar 20. Similarly, when the start time or the end time of a plurality of events is very close to each other, the events can also be displayed on the clock-calendar according to the arrangement method of the events 1001-1003 in FIG. 10

In the present embodiment, the user can also zoom in or zoom out a part of a display region used for displaying the clock-calendar according to the aforementioned spreading gesture or nipping gesture. For example, when the user performs the spreading gesture on the clock-calendar at a position corresponding to none of the events, the processor 12 zooms in the region corresponding to the position to clearly check the events in such region, and hides the events beyond the display range of the touch screen display 11. Conversely, when the user performs the nipping gesture on the clock-calendar at a position corresponding to none of the events, the processor 12 zooms out the region corresponding to the position to facilitate the user checking the originally hidden events in the clock-calendar. The user can also perform a dragging or sliding operation on the clock-calendar at a position corresponding to none of the events by using an input tool, so as to check the originally hidden events.

In summary, in the operating method and the portable electronic device of the disclosure, the gesture on the touch screen display corresponding to the clock-calendar is detected, and the clock-calendar is operated according to the gesture. In an embodiment, the aforementioned gesture is, for example, an event a delete event and/or an adjustment event, etc., and these operations respectively correspond to different gestures. In this way, different to the conventional calendar presented in a table form, the clock-calendar of the disclosure can be operated through different gestures, which effectively improves usability and operation fun of the calendar in the portable electronic device.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. An operating method for a portable electronic device having a touch screen display, wherein the touch screen display displays a clock-calendar having a clock pattern, the operating method comprising:
detecting an gesture on the touch screen display corresponding to the clock-calendar, wherein the gesture comprises an gesture starting point and an gesture finishing point;
analysing the gesture; and
operating the clock-calendar according to the gesture.

2. The operating method as claimed in claim 1, wherein when the gesture corresponds to an operation for creating an event, an event line segment corresponding to the event and event information corresponding to the gesture are displayed at a peripheral of the clock pattern, wherein the event line segment is used to represent a duration of the event, the gesture starting point corresponds to a start time of the event, and the gesture finishing point corresponds to an end time of the event.

3. The operating method as claimed in claim 2, further comprising:
displaying an edit window on the touch screen display to edit the event.

4. The operating method as claimed in claim 2, further comprising:
displaying a floating dialog box on the clock-calendar to edit the event.

5. The operating method as claimed in claim 1, wherein when the gesture corresponds to an operation for deleting an event, the gesture starting point of the gesture corresponds to an event line segment to be deleted in the clock-calendar.

6. The operating method as claimed in claim 1, wherein when the gesture corresponds to an operation for adjusting an event, the gesture starting point and the gesture finishing point of the gesture respectively correspond to a start time and an end time represented by an event line segment to be adjusted in the clock-calendar.

7. The operating method as claimed in claim 1, wherein when the gesture corresponds to an operation for changing a time period of the clock pattern, the time period is changed and displayed on the clock-calendar, wherein the time period comprises an ante meridiem time period and a post meridiem time period.

8. A portable electronic device, comprising:
a touch screen display, displaying a clock-calendar having a clock pattern, and detecting an gesture on the touch screen display corresponding to the clock-calendar, wherein the gesture comprises an gesture starting point and an gesture finishing point;
a processor, coupled to the touch screen display, analyzing the gesture, and operating the clock-calendar according to the gesture.

9. The portable electronic device as claimed in claim 8, wherein when the gesture corresponds to an operation for creating an event, an event line segment corresponding to the event and event information corresponding to the gesture are displayed at peripheral of the clock pattern, wherein the event line segment is used to represent a duration of the event, the gesture starting point corresponds to a start time of the event and the gesture finishing point corresponds to an end time of the event.

10. The portable electronic device as claimed in claim 8, further comprising displaying an edit window on the touch screen display to edit the event.

11. The portable electronic device as claimed in claim 8, further comprising displaying a floating dialog box on the clock-calendar to edit the event.
